(19) United States
(12) Patent Application Publication
(10) Pub. No.: US 2020/0320582 A1
(43) Pub. Date: Oct. 8, 2020

(54) SYSTEMS AND METHODS FOR AUTONOMOUS BRANDING USING A PLATFORM THAT CONTAINS A PLURALITY OF FEATURES AND FUNCTIONS THAT ENABLE ANY USER TO HAVE ACCESS TO A COMPLETE DIGITAL PRESENCE AND MONETIZATION OPPORTUNITIES WITH THE USE OF ARTIFICIAL INTELLIGENCE WITH BOTH CENTRALIZED AND PEER TO PEER NETWORK INTERFACES

(71) Applicant: RICHARD B. HOLLIS, SAN DIEGO, CA (US)

(72) Inventor: RICHARD B. HOLLIS, SAN DIEGO, CA (US)

(21) Appl. No.: 16/690,398

(22) Filed: Nov. 21, 2019

Related U.S. Application Data
(63) Continuation-in-part of application No. 16/374,721, filed on Apr. 3, 2019.

(51) Int. Cl. G06Q 30/02; H04L 12/58; G06N 3/04; G06N 20/00

(52) U.S. Cl. CPC G06Q 30/0277; H04L 51/32; H04L 51/36; G06Q 50/01; G06N 3/04; G06N 20/00; G06Q 30/0201

(57) ABSTRACT

Disclosed herein is a system and method optimizing and monetizing social media presence for commerce. The present invention further contemplates an artificially intelligent method for managing social media activity for promoting commerce. The system and method may be implemented by software designed for users such as, for example, small businesses, to manage and implement an online digital strategy via centralized or peer to peer information networks. A digital web-based platform, for example, may be used to establish and expand the online presence of a brand by using artificial intelligence. The systems and methods may be implemented to publish, syndicate, and monetize content in an automated and seamless manner from a single interface as well as to monitor and respond to information relevant to such content.

### PRIORITY CLAIMS

This application is a continuation in part of U.S. patent application Ser. No. 16/374,721, filed on Apr. 3, 2019. the contents of which are incorporated herein by reference in their entirety.

### BACKGROUND AND FIELD OF THE INVENTION

With the modern advent of so many developing social media and information databases, there exists more than ever before the need to empower individual users to effectively manage and optimize the use of multiple information and social media resources and provide technology that provides jobs to such users in a decentralized peer to peer economy. Thus far, some existing social media information systems are constructed in an opposite arrangement, tending to tie or draw users into a single platform. There exists a need for methods and systems to enable accessing technology normally restricted to large well-financed entities in an affordable and accessible manner to empower individuals, to democratize the internet and empower every user. Importantly, systems and methods to utilize technology for the masses and reward them through monetization methodologies for valuable contributions to society are more important than ever before. Personal branding methodology through software tools integrated to devices will power social commerce. The Internet of Things concept is rapidly emerging and individual users need the ability to efficiently optimize their own online experience through the utilization of the multitude of existing social media platforms and information sources that exist to expand their own social commerce standing. The overarching theme or need is to integrate the whole from all the fragmented parts to empower entrepreneurs and content creators in a digital or so-called “gig” economy.

In general, data is utilized to increase transparency, trust and authenticity to enable a trusted economy. Governance is optimized by building a trusted and authentic brand. Users are rewarded for genuine content that authenticates who they are and what value they contribute. Data becomes personalized with technology to advance liberty, freedom and democracy. Social commerce and the Internet of You (an individual's own internet experience) is desirable to optimize human potential and to improve the human condition through a modernized data driven economy filtered all the way down to each individual.

In order for free markets and capitalism to thrive the economy needs transparency, equal access to information and a shared moral framework (a framework with integrity) where rule of law governs towards and promotes suitable self-governance. There exists a need for methodologies to provide transparency, equal access to technologies that provide information and digital ethics that empower a digital information driven economy to global citizens. Optimized ad revenue shares and also profit shares with its users promote these ends. Indeed, such a methodology will lead to a new model of a collaborative and participatory economy of the future where a corporation or institutional entity will share in wealth creation with its users. Blockchain and other disruptive technologies that empower the ecosystem will constantly evolve the platform to provide access and equal access to valuable or desirable information.

There is a long felt need for a network connected platform for the purpose of monetizing an individual's own brand identity. Such a network or platform would solve problems with existing methodologies by autonomously building and monetizing social media presence and digital assets. Platforms that autonomously supported an individual brand while connecting influencers across social media spaces has not existed where interfaces are driven by artificially intelligent attendants that curate a user to expand its own social commerce through the use of more multiple social media platforms and information sources. In particular, what is essentially missing from the prior art is curated user content that is curated as to enhance a user's social media influence through the use of artificial intelligence across numerous platforms to develop social commerce. Specifically, the prior art is focused on building brand loyalty as to particular PLATFORMS and not the USER in a user centric manner (The Internet of You). For example, Facebook does not promote using SNAP and vice-versa. Conversely, with the present invention taught herein, what is disclosed for the first time is a network or peer to peer interface that realistically provides an average user the opportunity to monetize their own social media presence or social commerce, take steps to improve their presence, while controlling the disclosure of information to the public, by managing the myriad of networks available to users and using artificial intelligence to optimize each user's experiences. Accordingly, a primary purpose of the invention and its objective is to promote and aid the entrepreneurial spirit in the “gig” economy. According to the invention, a network or peer to peer information interface aggregates, captures, and interacts with data across multiple social media platforms and generates a new unique space, known by the inventor as a “Holospace” for the purpose of building a cross-platform functional brand identity. The present invention uses information source or brand expansion so that existing social media platforms will all be accessed and then configured to accept publications from the present invention interface, and then a user, and in turn, is curated to create optimized social media content so as to achieve optimized social commerce for the benefit of the USER as opposed to any particular platform.

This methodology is akin to “least cost routing” in the past, where telephone callers could intelligently, on a per phone call basis, decide whether ATT, MCI or Sprint should be selected to complete each phone call in order to minimize the cost of telephone calls, which led the local exchange carrier “by-pass”, so that long distance tariffs were able to be taken advantage of on a user by user and call by call basis. In much the same way, the present invention optimizes which social media platform best optimizes user experiences or optimizes social commerce for each user, yet, enables a user to take advantage of all existing social media platforms. The net result will be the expansion of the use of social media platforms to enable users to enhance their personal income by being able to control multiple social media platforms simultaneously, in a manner to optimize social commerce.

### SUMMARY OF THE INVENTION

Within the last decade, social media has established itself as a universal medium for communication, advertising, and self-promotion. As of 2017, 1 in 3 people in the world use some form of social media. The constant availability for the average person to be “connected” to others has caused an influx of social media platforms to be developed in the recent years. However, none of the platforms have allowed the average user to monetize their own digital assets and social media presence or build their own brand identity through the use of artificial intelligence, where a user may avail themselves of the best of what each platform has to offer.

In addition, the majority of platforms even go so far as to utilize a user's personal information to their own benefit. Targeted ads and audiences are made up of a user's information disclosed on a platform, that cost advertisers significant money to purchase, but unfortunately, do not benefit the provider of the information. In short, current methodologies fail to incorporate the average user in the monetization process, even where user provided data is valuable and already exists. Moreover, when various platforms such as Amazon or Facebook suggest what you want or what you need, it is ultimately centered around maximizing the profit for the platform. Indeed, even if veiled within “saving a user money”, it is still geared to promote sales for the benefit of the specific platform. Conversely, the present invention encourages users to create their own content, and to create it in a manner calculated to be successfully marketed. This curation of user content is enabled in many ways, including the use of an advanced digital camera that puts the user and the user's content in the most favorable light. In addition, off-line, the process of curating user content may be guided by past user results and the past analogous user results of others, and even based on the current social media platform realities, all without going “on-line” or pre-posting. In other words, marketing by trial and error is minimized, as well as trusting that any given platform “has a user's back” in terms of optimizing and enhancing the social commerce of that user.

It is clear however, that social media presents an avenue for potential monetization of an individual's personal brand. Persons with specific and large outreaches, or influences, can monetize their social media presence by joining with advertisers looking to promote their goods and services. As it stands now, the individuals most likely to capitalize on their social media presence tend to be either: 1) famous persons who are already have significant influence in non-social-media settings, or 2) “viral” sensations that luck into influence, often without intending to do so. The average user does not have adequate tools to build a monetizable social media presence, and with the present invention, that reality is overcome.

The present invention provides a simple methodology whereby users can be on equal footing with otherwise already famous people. First, users establish an information dashboard, connecting to a multitude of already existing social media platforms. Next, each user is curated to create content, and to link their user profiles to the profiles of other relevant and even famous people. In other words, a user by “tagging” onto others may build their own network. Next, a user will be curated, through the use of artificial intelligence to create more and better social media content, and then finally, publish it for wide distribution across various and a multitude of already existing social media platforms. Next, once the social commerce of each user is measured, and monitored via artificial intelligence, an artificially intelligent attendant can help a user manage its own brand or its so-called Internet of You, so that each user may own and develop its own social commerce, across either networked or peer to peer platforms, for publishing over and over, and for selling goods and services across the widest possible and most advantageous audience.

Additional issues surrounding the current methodology relate to the manner in which advertisers connect with influencers. There are methods in which an influencer and advertiser are paired. Thus, the existing influencer marketplaces tend to connect the most powerful influencers with advertisers without consideration regarding optimization. Advertising with such influencers tends to be expensive and without guarantee of result. There is a clear void with respect to monetizing the presence of influencers with a modest followings or targeted audiences.

In addition, self-promotion is a primary benefit of social platforms. However, currently existing social media platforms are typically singular, and do not allow for a way to interact across platforms to build brand identity. However, the work needed to monetize one's presence across platforms is significant and out of reach of the average user. Thus, even if an average user begins to build some level of influence on one platform, they are often stifled by their lack of presence on another platform. Moreover, there is no viable method for the average user to easily build their monetization power across multiple platforms organically and simultaneously.

The present invention seeks to optimize social media presence by improving brand identity across multiple platforms. It further seeks to provide an outlet for all users to advertise and connect with advertisers based on their influence. In particular, by rewarding self-promotion, the present invention provides an avenue for the average user to quickly monetize their online presence. Moreover, the platform provides a user the ability to build that presence across multiple outlets simultaneously.

Just as a generation ago least cost routing allowed MCI and Sprint to compete with then giant ATT, the present invention will allow true cross-platform marketing utilizing all platforms simultaneously such as with giants like Facebook, Google, Amazon, SNAP, and so forth. For example, decades ago, ATT owned what was referred to as the “bottle neck” or local exchange carriers through which virtually all communications passed. If a user wanted to make a phone call, it was required that the user needed to access common carrier services through the ATT bottleneck. This made multi-network dissemination of information very expensive. However, MCI and Sprint introduced by-pass technology, wherein users could dial a local (free) phone number to access the new long-distance platforms of MCI and Sprint. In that manner, a user could then access a multiple-services to make long distance calls. The results were dramatic. Users were no long beholden to ATT in terms of long-distance phone charges. In effect, by-pass enabled lower prices and the availability of more services, more bandwidth ultimately and dramatically increased capacity. In turn, phone number portability was born, wherein each user owned its own phone number, free to sign up with any communications provider.

According to the present invention, a user should be and is now able to own his or her own social commerce and for the “Internet of You” or in effect, an internet tailored to accommodate the wants and needs of each individual user. In that manner, people may for the first time have Facebook, Google, Amazon and others will all be available in real time to expand the information available to and available for publishing user created content, optimized based on among other things, demographics, for optimizing social commerce for that user.

According to the present invention, users create user content in a curated fashion. Enhanced camera devices and processes are used to give individual users the same abilities large corporations now have. Next, the users can tag onto the social media feeds of many other users with aligned or even opposing viewpoints, so that each user may develop a following. With that following, a user may create value in their brand, or optimize and enhance their own internet presence or create the internet of you or that user. In turn, a user may develop and optimize its own social commerce, and then create an overall expansion of information sharing between major social media platforms to compensate users for its own following or commerce.

The portal according to the present invention allows a user to create an account and offer services to other users for fixed prices (or undertake an offer if they are accepting of the compensation). This portal according to the present invention allows a user to use their personal talents as a means for making money while also making it easier for patrons to find people who may offer services that they require.

A major hurdle associated with improving brand identity over several platforms relates to information security. Currently, the existing platforms do not provide a method to secure or control disclosure of one's data and information. As a result, social media platforms have come under attack from hackers and negative actors. One method of securing background communications on social media is through a secure ledger blockchain network or insulated safe peer to peer structure. In other words, while cloud structured have been useful to promote growth, according to the present invention, a renewed emphasis on native or locally hosted data may be relied on in part so that each user may insulate and develop its own social commerce and hold that value for their own benefit, deriving compensation for it. In other words, a user may actually derive revenue from the social commerce they create via curated content creation and their linkage to other social user centers, so that one user may derive enhanced social commerce derived from other users and their social commerce, and so on.

Through the use of blockchain technology, the present invention seeks to disclose a secure ledger decentralized platform that provides a cost effective and improved method of secure social media transactions.

Blockchain technology (sometimes simply referred to as a blockchain) was developed and has been used in certain digital currency implementations. An example implementation and corresponding blockchain techniques are described in a 2008 article by Satoshi Nakamoto, called “Bitcoin: A Peer-to-Peer Electronic Cash System,” the entire contents of which are hereby incorporated by reference. With that being said, in certain embodiments discussed herein, the blockchain may be privately hosted (e.g., where all member nodes are run and provided by the same entity or a controlled group of entities). In certain example embodiments, the blockchain may be a distributed blockchain, such as the one provided by the bitcoin network. Thus, the term blockchain as used herein is not confined to the so-called blockchain that is only used for the bitcoin cryptographic currency. The use of Blockchain branch structure leads to various hubs which enables peer to peer bypass of even internet providers. So, it's possible for a Verizon 5g customer to be routed to ATT for various enhanced opportunities. In that way, large content providers such as the NFL can truly enable common carriers to all participate in the broadcast of their brand in real time. While it could create competition, in the end, the content creator, the NFL, could seriously enhance its revenue, with Blockchain content contracts becoming the norm.

The Blockchain is a data structure that stores a list of transactions and can be thought of as a distributed electronic ledger that records transactions between source identifier(s) and destination identifier(s). Every transaction is “to” a destination identifier that is associated with a public/private key pair. In creating a new transaction, outputs from other, prior transactions that are to the “from” address (which may be multiple different addresses derived from the same private key) are used as inputs for this new transaction. The new transaction is then encumbered with the public key associated with the “to” destination identifier. In other words, outputs from prior blockchain transactions are used as inputs for new transactions that are then signed using the public key associated with the destination address. The new Blockchain transaction is then submitted to the blockchain.

Once on the Blockchain multiple such transactions are bundled into a block and the block is linked to a prior block in the “Blockchain.” Computer nodes of the distributed system then maintain the blockchain and validate each new block (along with the transactions contained in the corresponding block). The techniques described herein make use of blockchain technology to address one or more problems with the conventional database systems

Blockchain technology holds great promise for a range of industries and business cases, including the patent asset class. That is because a Blockchain can be viewed as a type of shared database, the contents of which are verified and agreed upon by a network or independent actors. For a new piece of data (such as the owner of a newly issued patent) to be added to the Blockchain, the independent verifiers must come to a consensus on its validity.

Because each new set of transactions (a “block”) is cryptographically linked to the previous block, it is extraordinarily difficult to change data stored in a Blockchain and any such change would be readily detectable. Thus, blockchains are widely considered to be immutable and thus can serve as a record of proof of ownership.

When transacting in a Blockchain platform, each user makes use of a public address (needed for other actors in the network to send a transaction to that user), and a cryptographically paired “private key.” Private keys are used to sign transactions digitally, a form authentication to ensure that a given user has genuinely generated a transaction.

The Ethereum Blockchain was released in 2015. In addition to the distributed ledger capability of the Bitcoin Blockchain, the Ethereum Blockchain allows so-called “smart contracts,” which are programs stored in the Ethereum Blockchain that can act autonomously to execute sophisticated transactions.

Blockchain data transfer is currently considered one of the most secure technologies for digital asset transfer due to its distributed nature and use of sophisticated cryptography. Smart contracts, therefore, offer a potential solution for the management of patent transactions via the introduction of a universal, distributed ledger that does not require trust in a single third party.

Project Ethereum builds upon Bitcoin. Not only does it allow decentralized data storage in its blockchain, Ethereum also allows storing program code on its blockchain and running it concurrently by any number of network members. By predicating release of funds upon verifiable occurrences, Ethereum enables smart contract functionality. Basically, a network member uploads a computer program written in one of several permitted languages to the blockchain. The member may then condition the release of an amount of ETH (the currency underlying Ethereum) upon reaching the end of this program. Various network members thereafter run the program concurrently and reach a consensus on the resulted output.

The scripting languages in Ethereum or the IBM Hyperledger are Turing complete as they can implement any logic rules and initiate any calculations available. This feature allows any member to issue and trade with a custom virtual currency upon the Ethereum network. For the sake of clarity, a custom virtual currency issued and based upon another virtual currency is referred to as a Token. A Token may have various uses. While a certain Token will represent money, another Token will represent club member points or frequent flyer points. Tokens may be traded for ETH or for any other commodities and Tokens via the Ethereum or the IBM Hyperledger network.

Before Ethereum or the IBM Hyperledger, a person was required to launch a new blockchain utilizing custom user clients and mining algorithm, in order to issue a custom decentralized virtual currency. The emergence of the Ethereum or the IBM Hyperledger network allows easy issuance of Tokens with minimal setup. It should be mentioned that after Ethereum, several other virtual currency networks implementing smart contracts were established. Prominent examples include the IBM Hyperledger, Lisk and RootStock.

These are just a few ways that the invention has implemented their belief of monetization of services. The inventors believe that entrepreneurism has dwindled in recent years and they strive to expose the millennial population to the idea of capitalizing on their abilities. The invention “combines everything needed to build a personal brand and utilize it to make money or achieve a personal goal into one space”. While much has been said about peer to peer and network centric data distribution, according to the preset invention, a return to localized hardware is envisioned. By entrusting one's brand or social commerce to a “cloud”, a user's curated content value is minimized. Instead, according to the present invention, a user has an attendant feature (resident in a local device such as a pc or smartphone), that is capable of by-passing less favorable information conduits and pick optimal conduits. In addition, when using a camera for example, a user is coached or curated as to what and how to implement a camera for maximum social commerce development. In addition, commerce may be financially accounted for via the blockchain, but preferably, by an encrypted private wallet, which at its core, is biometric data associated with each user, such as eye scans of fingerprints. Consequently, on-line contracts may not be solely relied upon.

The inventor's mission statement is that “anyone with ideas, skills, talents, passions and the hustle to make it happen can be an entrepreneur. The invention was created to empower all individuals, businesses and organizations with the ability to thrive in today's digital economy.” As the world changes in how people make money, it is important for more and more modes of capitalizing to sprout. The invention is the first of its kind to operate as a platform designed and intended to function as a medium for capitalism. In order to build a brand, one must have the tools and the support to do so. The invention provides all of the essentials and more in order to take the spirit of entrepreneurship to the next level.

Another important aspect of this invention relates to artificial intelligence in the promotion of an average user's brand identity. Specifically, the existing platform envisions an autonomous engine that recursively optimizes the actions a user can take across multiple platforms to increase their social media presence and thus their ability to monetize their individual brand. By reviewing a user's network, habits, and potential, an artificial network deployed on a blockchain can securely aid in the autonomous improvement of one's online presence, thus allowing for greater potential with less effort. Importantly, the Web is no longer just a “web”, it is growing faster and farther than we ever imagined possible. Within a relative few short years, the connectivity created by the Internet is shaping lives, driving users of electronic media to evolve the way we think, how we use tools and information, and how we perceive of and create opportunities for sustainability and financial freedom. So that the present invention may truly lead to the democratization of social commerce, independent off-line data structures are utilized, so that social media content may be curated and optimized by a user, off-line, but with comparison and through the utilization of on-line realities, so that a user may build its message and branding without the fear of launching or posting prematurely. According to the present invention, a user may be curated to develop social media content, and then, market that content, when ready, to multiple social media platforms to create an expanded and optimized marketplace and for that user to achieve optimized social commerce.

Today, the rapid innovative nature of technology, and low barrier to entry creates a field of potentiality that must be explored by every citizen on the planet. We are enabled with an unprecedented era looming before us, in which to empower the human species like never before. To reach new heights of creative achievement, to economically stabilize entire societies, and to connect disparate eco-systems into a cohesive whole, bridging the divide between concerns to give birth to new solutions and disruption.

By cognitively enhancing the individual with tools, deep connectivity and access to knowledge, services, supplies, and communications, we give rise to the Holon; the person, and all their passion, drive and ingenuity. But, when we empower the masses with the same tools and access, we can then see the singularity for what it is. A combination of people, cultures, science, data and wisdom, financial growth and stability which is accessible to all. It is this ubiquity, and the ability to be “everywhere”, available on any device, any screen, at any time that has created this kinetic, on-demand economy. Economic empowerment through free access to commerce and the tools which drive content. Open distribution channels within global and social networks, along with the integration of products and services into the conversations and engagement where buyers and sellers communicate, make decisions and feel comfortable with curating their discoveries.

This convergence is happening all around us, every day. It is driven by data, how we create data, where the data goes, how it is collected, and what mechanisms are processing data. Not only data from the world, but data you specifically generate. It is these convergences, along with media and content, which will drive the future of peer-to-peer economies. The opportunity is in recognizing that the “Internet of Things”, the “Block Chain”, “Intelligent Content, and the data we create are on the cusp of combinatorial innovation, and we want to be at the forefront of this tidal wave. Indeed, the Internet of Things is enabling communications continuity everywhere and seamless human interaction, particularly via biometric sensors or wearables for monitoring human status and virtual reality and augmented reality for enabling humans to interact more efficiently with machines.

In addition, The Internet of Things (IoT) enables systems of interrelated computing devices, mechanical and digital machines, objects, animals or people that are provided with unique identifiers (UIDs) and the ability to transfer data over a network or in a peer to peer (via the Blockchain) without requiring human-to-human or human-to-computer interaction. The definition of the IoT has evolved due to the convergence of multiple technologies, real-time analytics, machine learning, commodity sensors, and embedded systems. Traditional fields of embedded systems, wireless sensor networks, control systems, automation (including home and building automation), and others all contribute to enabling the Internet of Things. When combined with virtual or augmented reality, a curated and simulated experience that can be similar to or completely different from the real world may be provided and commercial transactions enabled, e.g., the purchase or usage of goods and services, transaction of intellectual or real property and so on. Other applications of virtual or augmented reality can include entertainment (i.e. gaming) and educational purposes (i.e. medical or military training). In addition, various forms of so-called “mixed reality” may be employed as desired. With respect to augmented reality, it is important to recognize that devices such as electronic glasses may enable humans to see their real life surroundings, coupled with visualizations of other descriptive or directive indices.

Combining augmented and virtual reality with artificial intelligence or AI enables intelligence demonstrated by machines to be unlocked and optimized for human experiences, in contrast to the natural intelligence displayed by humans. AI can be defined as any device that perceives its environment and takes actions that maximize its chance of successfully achieving its goals. AI is often used to describe machines (or computers) that mimic cognitive functions that humans associate with the human mind, such as learning and problem solving.

Humans are machines of consumption, and we use machines to consume information. Primarily the main feed according to the present invention is comprised of the content and information that is published by users who are “Followed” by other users that find interest or want to be connected to each other. Much like your Instagram, Facebook, Twitter or LinkedIn feeds, when you follow someone their activities begin to appear in your feed based on a timeline, relationships, and other proprietary factors. It is anticipated that various information sources will be evaluated and then optimized for use for developing and enhancing a user's social commerce.

The very nature of the information sources within the present invention is unique because of several combinatorial effects. The platform according to the present invention is designed to enable and empower the digital presence of its' users. Direct content production is usually reserved for stand-alone websites, media sites, news sites or blogs. Through their own digital spaces, the user has the ability to create unique long form content, short textual or media posts, products, services and even curation and distribution of information and links from outside of their own digital spaces, within all the aforementioned content types.

Social media platforms such as Facebook and Instagram were originally designed as curative engines, but as the convergence of media, tools and data continues to evolve, even these platforms are striving to open their offerings, to expand where and how users can produce and consume data.

For example, Instagram enables you to upload images and short form video content. They do not allow you to curate links and other content data from outside of their eco-system. Recently they have begun to enable product discovery, but this is deceptive in the sense that once you tag a product on Instagram, to purchase that product you must exit the platform and be exposed to that seller's experience, rather than a standard, more enjoyable and predictable mobile standard like in many marketplaces. So, Instagram is becoming a marketplace, but it is not operating as a true marketplace experience, along with many limitations in the various content types. Instagram also does not position content as discoverable by search engines, they do not take the time to empower their code to speak to search engines or enable their links to be curated by other platforms such as Twitter. Again, a vast limitation, which does not necessarily harm them or their business, but leaves users without a critical tool in their digital arsenal to being discovered.

For example, Facebook enables a user to upload images, longer form videos and curate massive content from outside of their eco-system. Facebook was predicated on curation first, but not creation. In fact, other than a public profile, unless you manage and operate a “Business Page”, there is no direct search engine discoverability to anything that is produced with the Facebook eco-system.

Over the past several years Facebook has been creating their Instant Articles content management system (CMS), which essentially copies the information from a webpage and distributes that within the internal Facebook eco-system for a superior experience of speed and consumption when accessing said content from within their app. This is in direct response to the lack of expertise and technical infrastructure that most standalone websites have to support such experiences. And also, to optimize Ad insertion and monetization strategies. But, when considering this objective, it still falls short of easily enabling the production of multiple content types from a single point for every person and not just the enterprise.

According to the present invention, the information platforms that contain a user's aggregated followers publishing activities is generally private, but many other information sources are completely open and designed to be fluidly index-able by search engines. When the user publishes any content within the platform according to the present invention, it automatically gets sent to the user's “Home” feed, which is structured to be discovered by search engines and is always publicly available. Although this is considered a “feed” or data steam (an information resource broadly speaking) it is actually a series of paginated URL's that are positioned under a user's unique address within a platform according to the present invention. This is a significant method of ensuring that from one single piece of content, to 100,000 pieces of content, whatever is produced by the user will always be found and associated to their identity wherever that content may be distributed in the future.

There are some messaging app eco-systems which are experiencing explosive growth today, and entire networks of users that are successfully driving traffic and converting consumers from these efforts. One of the most recognizable apps at the moment is of course Snapchat. WeChat, another messaging app launched in China, with over 600 million users currently is another case to consider. Our approach to messaging today is rudimentary, very simple and straightforward textual communications that enable users to reach out to one another and maintain a history, but the vision for our messaging platform tomorrow is completely different, enabling sellers and buyers to transact on products or services directly from their chats and conversations. Distributing funds and moving monies across the block chain. Transferring asset backed content ownership to other connecting affiliates data, tracking, reporting and discoverability. Allowing businesses to connect sensors and deliver real-time services to consumers as they walk through their doors, further spurring localization and bridging the gap between intelligent marketing, personalization and effective in-demand delivery of conversion value.

A draft document or data file can indefinitely live as unpublished content, and it is entirely dependent on the individual user and is designed so that people can take their time when creating long form landing pages, products, services and even channels. Any content can be edited, iterated and resaved as a draft as many times as is necessary, until the user feels comfortable with publishing their creativity to the world. Once published, the user may also edit content and save their edits as a draft. This ensures that iterations, creativity and adding information can be a fluid experience without disrupting or altering the original publication until the user is comfortable with pushing changes out. Generally drafting content is reserved for content management systems and website builders like Wordpress, Wix, and even blogging platforms like Medium, but you do not see any CMS draft or versioning functions in social media platforms, let alone in mobile apps. This combination is not something which is commonly developed, again probably because the original paradigm for social media was curative rather than creational.

The peer-to-peer, on-demand economy is upon us, and it has been for some time. But it is only recently where the convergence of the tools, platforms and opportunities to mainstream collaborative efforts has emerged, that enables users to participate in creational efforts, or even to hire out the skills that might be lacking in their digital strata.

Some people are exceptional writers, or photographers, videographers, journalists and even online social marketers. Some have grown tremendous followers on other networks like Instagram, Twitter and Facebook, and use those networks to cross promote merchandise, brands and other products. Whatever our skills, every person should be enabled to collaborate with another user, business or project. The draft system empowers any user according to the present invention to reach out to another and “invite” them to become a contributor or author. Users can choose to accept or decline, but this function is designed so that each user can develop relationships with other content producers, influencers and creators and have them directly collaborate when publishing content. A user according to the present invention could conceivably create a service promoting their writing skills or network capacity for views and impressions, and another user could purchase that service, and through that partnership grant access to their content tools and social sharing mechanisms.

There are some similarities to consider, for example on Facebook you can invite other Facebook users to be an “Admin” of your page, which enables the ability to upload images, videos and posts on your behalf. Also managing other functions and efforts like ads placement, information management and apps, but this access is not centered or focused specifically on the collaborative process, content production and cross-optimization of networks. When an author creates content on your behalf, and is published, much like the major news sites, that user is given credit for the creation through a direct link to their page, product or channel. Authors can distribute what they create to their networks, websites and social media destinations as well as the owner of the content. Authors are able to collaborate with owners and use imagery, links, videos and other content from their own repositories. This subtle combination of functions and flows is something which connects networks, distribution, media assets, creativity and skills into a new paradigm where each user has the capacity to be both a business and a destination. However, managing this overwhelming combination of information resources has become often arbitrary and impossible to optimize in a manner geared towards accommodating the needs of each user.

Open marketplace eco-systems are part of the peer-to-peer future, and in order to empower and enable this opportunity the user according to the present invention must be able to both sell and buy without barriers or major differences in the standardization of the experience. A user should be able to create a product in one moment and decide to buy in the next, and the experience of doing that is easy, fluid and centralized. In transactions, the user can see, in one snapshot, all their purchases, and purchase invoices; and everything they've sold, who it's been sold to, their email addresses and ratings on those orders.

In inventory, the user can see every product they have available and are currently selling. Inventory is searchable from here and can be filtered by type as well. A user can also start creating from this screen as well. However, in order for products and services to monetize effectively, there are many other combinations of functions and features which needs to be considered in order for a full strategy to blossom. It is this schism between skill and creativity where many “sellers” fail, and where many systems do not consider the entire life-cycle and nature of the supply chain. For example, an artisan in Africa can make a connection to a reseller in the US, who has a local shop in San Diego, Calif. Both participants can manage and update inventory internally, share their stories, networks and insight to create a new story. The African artist is never required to move out of the invention platform eco-system to collaborate with their client in the US, yet their products are now seen and distributed to many other potential shops, networks and resellers. Furthermore, other local artists discover this new connection, and the potential for the supply-chain can become exponential.

When creating the product or service, the user according to the present invention editor enables the embedding of social content from outside of the platform. Partners can easily use this content to highlight their relationships and even provide connectivity to conversations and media posted on their respective pages by fans, followers and customers. This creates a new way of exposing the growth of their networks to each other as these new conversations and pages get discovered. Many stand-alone ecommerce websites and platforms are focused on the seller experience and require not only the skills to create and manage products and inventory, but all the myriad problems that arise from trying to optimize SEO, decide on navigation, proper keyword hierarchy, UI design, UX flow, and the list goes on. This remains today one of the largest barriers and pain points to small businesses and entrepreneurs, that building the website is prohibitive, even understanding social media marketing strategies in conjunction with a website is daunting.

Any operating system ever developed has a core set of basic components, functions, and tasks which enables it to support applications. As used herein, the term operating system may or may not be so defined. Every application may access those common traits in order to operate, such as screen display to see data, media or information, keyboard & mouse to insert data, move cursors, interact with options, processors to move data and bytes and storage to record data and information. Each user data space according to the present invention has been designed as its' own operating system as defined by this invention with a core set of components, functions and tasks that enables it to connect to other applications with the purpose of expanding the data, distribution and potential to reach and communicate with other eco-systems. All apps currently in the platform, and many others which will be connected are fulfilling two basic and fundamental principles: to bring content, media, information, products & data to the user and to distribute content, media, information, products & data out from the users.

According to the present invention, a user may upload video content directly from the Web, or from their mobile device to any post, page, product or service they are creating. After a video has been uploaded, the system enables the video to be immediately playable. In the background, there are queued processes that take the original video file and transcode (transform) the data into a format that is compressed, delivered to the users' player faster, and works on more mobile devices, as some video files do not play on older technology. As these files are played or watched more often, they become cached, making them faster. Every video, regardless of where or when it was uploaded, is added to a library so that it can be re-embedded into any other content at a later time. Furthermore, video content is monetizable, meaning it is integrated an ad server to display pre-roll filler and banner ads. In the re-use flow mentioned above, and if the user was verified, using the video in content again and again, then distributing that content to gain the maximum number of views and impressions would result in a growing revenue stream. This combination of reusable media assets, multiple content types, distribution and monetization becomes a unique lynchpin in understanding the makeup of future user generated video platforms.

As social media has evolved it has become abundantly clear that people have not just one, but multiple passions and interests that they like to express, especially over time. It is a part of the fundamental nature of being human, curious, curative, creative; we are adventurers at heart and will always find a way to steer our own courses towards the things we gravitate to. We also evolve, change, grow, and our outlooks, needs and wants likewise do as well. Accordingly, artificial intelligence will allow the platform according to the present invention to morph and scale according to the needs and desires of the users according to the present invention. When publishing content and media, the user is allowed to immerse themselves in the act of creation or curation, and before finalizing they are given the choice to “send” the publication to any of their personas.

Products and services may also be thought of as pages in a sense according to the present invention but constructed in such a way that it enables the user to publish within a more traditional ecommerce experience, yet still maintain the combinatorial effects of telling a story, embedding content and distributing socially. When comparing the product construction experience according to the present invention to other marketplaces or stand-alone ecommerce website builders, the differences are easily recognizable to the initiated, and should be something easily adopted by those with no previous exposure. Products and services, or just items, can be constructed as paid or free, with having limited or unlimited inventory choices. This means you can create a coupon and make it free to promote an event, a community gathering, a concert, a local club, or even a restaurant.

These and other features, embodiments, and aspects of the present invention can be appreciated from the following drawing description and detailed description of the preferred embodiment. Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any invention described herein.

### BRIEF DESCRIPTION OF THE DRAWINGS

FIG. 1 is a diagram of the advertising monetization system of the present invention.

FIG. 2 is a diagram of the AI feedback cycle of the present invention.

FIG. 3 is a flow diagram of one present embodiment.

FIG. 4 is a system diagram of one embodiment of the network.

FIG. 5 is a network diagram showing a blockchain network as contemplated in the present invention.

FIG. 6 is a diagram of the overall advertising monetization method of the present invention.

FIG. 7 is a diagram of the advertising monetization page creation method of the present invention.

FIG. 8 is a diagram of the advertising monetization ad placement method of the present invention.

FIG. 9 is a diagram of the buyer offer method of the present invention.

FIG. 10 is a diagram of the buyer offer method of the present invention.

FIG. 11 is a diagram of the offer cancellation process of the present invention.

FIG. 12 is a diagram of the offer fulfillment process of the present invention.

FIG. 13 is an overview of the combinatorial ecosystem of the present invention.

FIG. 14 is an overview diagram of the combinatorial ecosystem platform of the present invention.

### DETAILED DESCRIPTION OF THE PREFERRED EMBODIMENT

The proposed invention discloses a platform for monetizing social media presence. It can be deployed on both a traditional centralized network or a secure ledger, or blockchain network. In addition, the present invention may use data analytics to implement a system that can provide a customized and artificially intelligent optimizations. Such optimizations can result in cross platform improvements that seek to improve the reach, influence, presence, of the average social media user across multiple outlets. In addition, the same optimizations may result in the increased ability of the average user to monetize their individual brand and social media presence.

The advent of the internet has brought forth various ways for individuals, businesses, and entities to connect on a global level. Such are often based on centralized platforms that allows for interaction amongst various subscribers. However, these social media outlets often fail to empower average users with the tools needed to monetize their presence.

Specifically, current social media networks present several avenues where the platform owner, rather than the subscriber can profit from the user's presence: 1) The collection and sale of user data; 2) forced and targeted advertising services to users based on their data; and 3) an advantage in understanding the popularity of certain business models and services due to their mass collection of private data. In the rare instances where average users can monetize their presence, the social media platforms do not provide a globalized method of transactions. The present invention seeks to provide a more efficient system and method to empower all user to easily manage various platforms and monetize their online presence on a global scale. It further provides a marketplace where any user can connect with advertisers or other users and take advantage of their audience. The platform envisions a method of directly rewarding users for their social media activity.

In some embodiments, the systems and methods disclosed herein can be implemented by hardware and software designed for average users or businesses. Businesses, for example, may manage and implement their online digital strategy based on the availability of specific and moderate influencers. Additionally, in some embodiments, the platform allows users to easily build a web-based storefront to establish and expand their brand's online presence.

Various systems and methods disclosed herein can be implemented by users to publish, syndicate, and monetize their social media presence as well as to monitor and respond to information relevant to their success. The platform as implemented with the hardware and software as described herein provides significant advantages to businesses over other platforms such as Facebook and LinkedIn or various other platforms for enhancing and managing their electronic interactions with other businesses and consumers.

Some embodiments comprise a software framework having a modular architecture. Modules can comprise independent software applications and/or processes that can deliver relevant and customizable feature sets to different users. For example, modules can be business specific with the goal of attracting and/or retaining customers.

In some embodiments the systems interact with or adopt at least one social media component. Social media components may include, for example, Twitter, Facebook, YouTube, Snapchat, or any other online social platform. Modular components and/or applications can combine multiple types of content (including social media content), create content (including social media content), and publish the content within a specific section of a larger software or web-based platform.

The system can include a platform comprising “digital spaces.” A “digital space,” or “Holospace” is a combination of computer memory and computer processor instructions that are configured to store content created by a given platform subscriber, display some or all of the stored content to visitors of the platform in response to visitor search queries, push some or all of the stored content and/or links to some or all of the stored content to servers and storage locations on the internet different from the memory associated with the digital space, and present to the platform subscriber a user interface (sometimes referred to as a dashboard herein) allowing the subscriber to control some or all of the above described functionality. As such, each digital space can be accessed by at least one subscriber. In some embodiments, subscribers can create content and publish the content in selected media categories. In response to this publication, the system can automatically generate a unique RSS feed for each media category that the users publish into. Distribution services can extend each feed type as an outbound marketing tool into local RSS search engines, popular readers and/or other websites.

In another embodiment, a user's digital space may also include the ability to interact with an integrated marketing center. The application can be displayed in a user's digital space. The marketing center can utilize content and media creation assets and suggest a marketing approach specific to the user. Processes can monitor specific interactions with consumers, geographic and industry category trends, historical decisions and trends, and third-party input. The system can then suggest insights and standardization for distribution across social channels, paid search channels, banner, and localized GEO Mobile interactions.

In some embodiments, a user's digital space can include systems and processes that can track and discover factors which affect SEO rank positions for keyword searches by end-users. The methods can abstract from current web crawler approaches by compiling data from standard sources, social sources, media sources, communication sources, syndication and user-oriented re-syndication action sources, and use proprietary mathematical models for distilling this data into easily recognizable actions triggered by content and media creation. The system can provide suggestions to the user and or display the results in the user's digital space.

Some embodiments include systems and methods for end-users or consumers to join and interact with any platform or technology developed by the user. For example, the systems can archive and track the media content and historical references for the life of the user. Users that are given access to the platform can engage in one-to-one direct communication with other user accounts on the platform. The system can collect specific data on consumer and/or user behavior, product choices, communication sequences, conversation modeling, and many other mathematical factors. This user and/or consumer data can be embedded into enterprise analytics products.

In some embodiments, a user's digital space can include systems and processes constructed from an Abstract Factory Pattern to recreate the directory, experience, and media assets of the user's business on the platform into a social network fan or account page. The systems and methods can include managing complex API integrations with existing and emerging social networks and carrying third-party integrations from one platform to another to provide the user's business with value in consuming products that previously did not operate well cross-platform.

In some embodiments, a digital space can be launched for any social media business or large-scale entity wanting to empower sales or marketing teams with dedicated publishing spaces for direct one-to-one interaction with consumers. This single “push” management offers highly scalable opportunities to manage huge networks like hosted datacenters. Digital spaces can be linked and information can be shared and tracked in order to monitor to development, growth, new product releases, and/or enhancements offered by related users.

A digital space may also include a virtual storefront. The storefront may enable a business to efficiently manage their advertising, branding, and online presence. The software modules may include a standard set of pre-bundled dynamic displays that users can interact with. In some embodiments, subscribers can customize the digital space and/or storefront through an interface accessible to subscribers.

The interface may include a dashboard. The dashboard may comprise one or more software modules that include interactive displays. The dashboard may allow a subscriber to edit the digital space. For example, dashboard may allow for a subscriber to reposition elements, change design choices, and manage their digital space. In some embodiments, a subscriber's dashboard includes applications and features designed to order information, generate communication and archive resources, products, and/or services from the platforms that the digital space interacts with and/or from the web in general. In some embodiments, the dashboard mimics a mobile desktop environment.

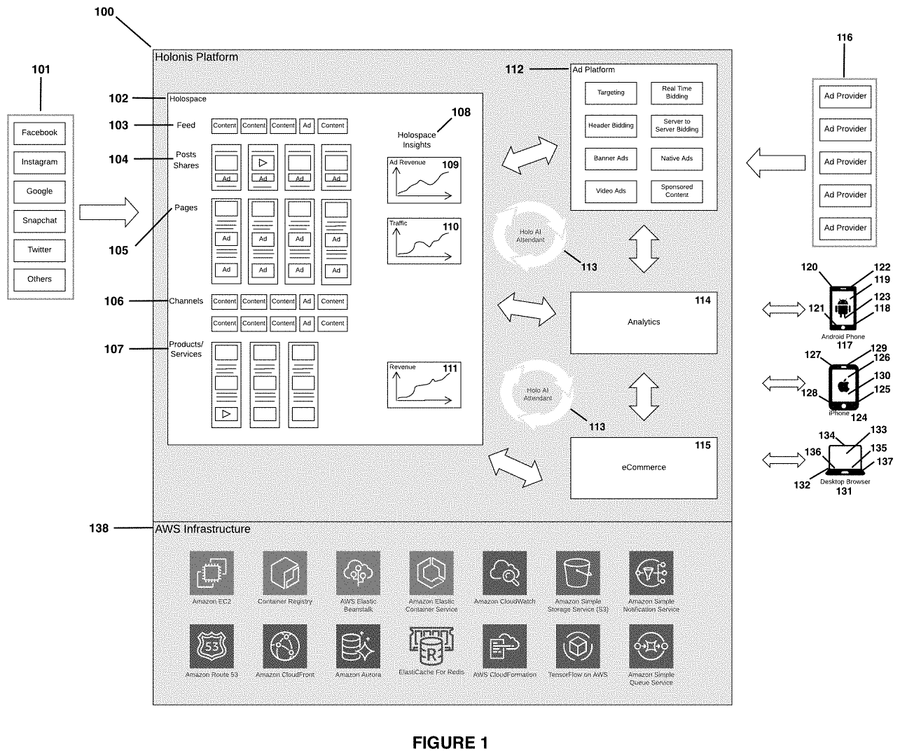

FIG. 1 is a diagram of one embodiment of the advertising monetization system of the present invention. The platform of the present invention 100 creates a link for external social media user accounts 101 to a Holospace user portal 102. The Holospace 102 consists of: a content feed 103; shared posts 104; user profile pages 105; content channels 106; and products and services pages 107. The Holospace 102 also consists of Holospace Insights 108, an analytics engine providing data such as: generated ad revenue 109; user traffic 110; and e-commerce sales revenue 111. The Holospace 102 can also provide access to various ad platform options 112, such as: targeting; real-time bidding; header bidding; server to server bidding; banner ads; native ads; video ads; and sponsored content. Both the Holospace 102 and the advertising platform 112 are can access platform insights 108. The advertising platform 112 has an additional analytics engine 114 that provides external ad providers 116 with data collected from the overall Holonis Platform 100. This advertising analytics engine 114 can receive and contribute data through an AI (artificially automated) attendant 113.

Attendant 113 enables user input to be evaluated each time it is entered into an individual user's network space or so-called “Holospace”, and then used to maximize each user's interactions with their own user spaces during future interactions, so that user input may often lead to unexpected results which are nonetheless desirable or advantageous. The advertising analytics engine 114 also corresponds with the eCommerce engine 115, which can also receive and contribute data through an AI attendant 113.

The platform 100 is accessed by smartphone via applications on either Android 117 or iOS 124, or by a desktop browser 131. A smartphone with an Android operating system 117 uses an Input/Output (I/O) port 118; a display screen 119; a camera 120; a microphone 121; a speaker 122; and a keypad 123. A smartphone with an iOS operating system 124 uses: an Input/Output (I/O) port 125; a display screen 126; a camera 127; a microphone 128; a speaker 129; and a keypad 130. A desktop browser 131 uses an Input/Output (I/O) port 132; a display screen 133; a camera 134; a microphone 135; a speaker 136; and a keypad 137. The overall platform 100 operates through an Amazon Web services (“AWS”) infrastructure 138.

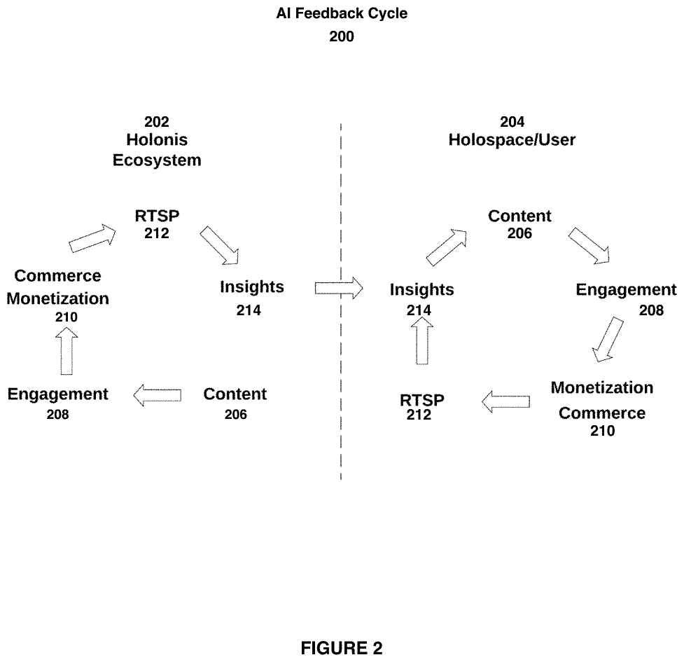

FIG. 2 is a diagram of the AI feedback cycle 200 of the present invention. Section 204 of the diagram is focused on what takes place within a single user's Holospace and their presence in the ecosystem. Section 202 of the diagram is for the ecosystem in its entirety considering all users on the platform and their interactions. Users can create content 206 in the ecosystem, such as: short-form text, image or video posts (posts); longer form articles and blogs (pages); curated lists of content (channels); and physical and virtual products or services that can be fixed priced, offer based or recurring, i.e. subscription based. The content 206 uploaded by users is automatically analyzed to derive more meaningful context from the content. Getting additional context from the content 206 is important to provide more input data points to the neural network to learn from. Images will be analyzed to extract any text embedded in the content. Uploaded images will run through a classification process to identify potential content categories for the image. A facial recognition process will also be run on the visual information and any known persons will be recorded with the content 206. Uploaded videos will be analyzed just like images to extract relevant information. In addition to processing the visual information videos will also run through a speech to text analyzer to extract relevant information. A text analysis will be performed on all text in the content 206 whether typed directly, extracted from visual information or extracted from speech to text analyzers. This analysis will extract relevant categories and tags as well as a sentiment analysis. This information automatically extracted from the content 206 will be associated with said content 206 and fed to the neural network.

This content 206 in the ecosystem which drives engagement 208. Other users on the platform and visitors can engage 208 with the user's content in a variety of ways through direct interactions such as: liking; sharing; commenting; and purchasing. There are also a number of indirect methods of engagement 208 that are being recorded as users explore the platform, such as: impressions, when users come across content in listing views like feeds of content; views, when users either click into a piece of content or spend enough time on a piece of content in listing views; and reads, when users fully explore a blog or article this gets recorded as a read. Users can also directly engage 208 with the user that posted the content 206 following said user or sending said user a direct message. Just as the Holospace content 206 is analyzed, the engagement 208 with the Holospace can be analyzed with the same methods. Other users mostly interact with the Holospace through text either via comments, reviews or direct messages. This text can also be analyzed as described above. This information will help the Holospace owner understand at scale how users feel about their engagement 208 with the Holospace. As this gets tied into the detailed knowledge about the content 206, very specific insights 214 can be generated.

This engagement 208 can be monetized in the ecosystem through automated and optimized ad-placements, and drive ecommerce 210 as users who otherwise engage 208 with the other content 206 in the Holospace will come across products and services which will lead to conversions. The data from the engagement 208, ad monetization and ecommerce activities 210 is then fed into a Real-time Streaming Platform (RTSP) 212, which processes this data in real-time and calculates derived analytics that are instantly available. The data from the RTSP 212 is fed into a personalized neural network for the specific user. The neural network generates insights 214 that helps the user optimize their presence on the platform. As the user acts on the insights 214 the system will measure the results and will learn from its own recommendations and fine-tune the neural network to provide even better insights. This cycle of learning and improvement doesn't just happen for a single Holospace.

The entire ecosystem is learning from all of the aggregate data and actions taken across the entire platform. When individual Holospaces 204 are first created there's no data to bootstrap their personalized neural network so Holospaces neural networks are initially created with the shared knowledge of the entire ecosystem 202. As the ecosystem 202 continues to learn and get smarter this gained knowledge will continuously be fed into the Holospaces 204 personalized neural networks, but those neural networks will also increasingly be personalized. Since data is streaming in real-time in the RTSP 212 this learning feedback cycle 200 is continuous and therefore lessons can be learned and acted upon very quickly. These quick iterations will accelerate the learning of the ecosystem. As the neural networks evolve, the recommendations for Holospace actions become more accurate. The Holospace can choose to let the neural network automatically carry out the actions. Examples of actions that can be automatically carried out by the system include but are not limited to: deleting content 206 that receives negative feedback from the Holospace's user base; providing immediate follow up responses to users who are unhappy with a transaction 210; and boosting advertisement monetization 210 on well performing advertisement campaigns as long as a defined parameter is met.

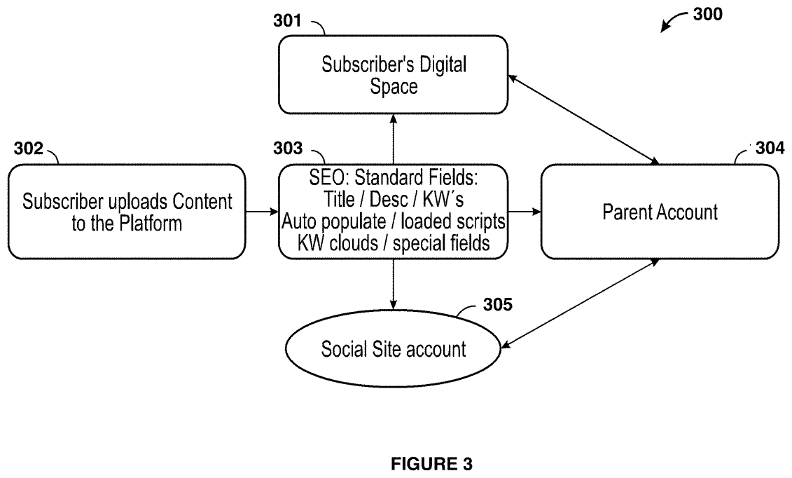

Turning to FIG. 3, a block diagram of a system and method of distributing content 300 is illustrated. A subscriber's digital space 301 may include a plurality of webpages. New webpages on the digital space 301 may be created when a subscriber uploads content to the platform 302. The uploaded content 302 may be search engine optimized in at least a partially automated manner 303. In some embodiments, the search engine optimization 303 includes prompting a subscriber for additional information about the uploaded content, labeling the content with a title, description, and keywords, and/or providing meta tags. Uploaded content 302 that is SEO optimized 303 may then be published on the digital space 301 and the subscriber's social media website account(s) 305 automatically. In some embodiments, a parent account 304 may be linked to the digital space 301 and the social media website account(s) 305.

In some embodiments, a subscriber may be required to receive prior approval of content that is displayed in the subscriber's digital space and/or syndicated through the subscriber's channels. One or more software modules may be configured to fully or partially provide for review the content for key words or obscene content. This functionality may be referred to as a compliance engine. In some embodiments, content approval may be provided by the subscriber's parent account or company. For example, in some industries, a subscriber may be an independent contractor or agent affiliated with an organization. The organization may require that all content published to the internet be pre-approve or compliant with the organization's standards and/or advertising campaign and/or brand message. Thus, in some embodiments, content that a subscriber wishes to display on their digital site and/or syndicate must first be sent to the subscriber's organization or parent account. If the subscriber's organization or parent account approves the content, then the content may be published and/or syndicated. If the content is not approved, the content may be returned to the subscriber.

In some embodiments, the platform can include systems and methods that can extract keyword relevancy at the semantic and natural language level. The methods of collection can focus on internal interaction of the platform or any deployed platform anywhere on the web, accesses content spiders which crawl the web, and/or accesses Google's index and/or Facebook's Social Graph. The process can compile massive contextual information into an intuitive interface that offers full sentence related suggestions that are highly relevant, while the business is in the process of creation.

In some embodiments, systems disclosed herein are configured to capture, tag, play, and edit video content uploaded to the platform One or more software modules may be configured to upload a single piece of video content into a unique dedicated page structure that is optimized for full search engine visibility, sharing, conversion, and broadcasting to participating channels and/or social accounts. Subscribers may create unlimited unique pages, with each page acting as a unique entry point into the subscriber's digital space. Each page can also function as a page for generating and responding to comments from customers, answering questions, and creating deeper engagement with the public through streamlined central messaging.

Editing of uploaded video may be accomplished with one or more software modules configured to, for example, trim, stabilize, insert transitions, annotate, and/or add music or text to the video. Uploaded video may be edited immediately after upload or at a later time. Fields to capture meta information can be supplied to the subscriber before finalizing the public availability of the content. Subsystems such as predicative keyword and tagging insertion, help annotations, and links for industry, geographic location, and category.

In some embodiments, meta tagging is supplied by an intelligently learning keyword driven database that measures one or more factors of the upload and suggests anything from a single word to full sentences recognized as potentially optimized for that particular businesses location, industry, categories, and products. Video may be uploaded from a storage system or captured live from, for example, a webcam in addition, mobile browsers may initiate the same action through, for example, an HTML 5 enabled interface. In some embodiments, video may be uploaded directly from a mobile device.

In some embodiments, the platform can include systems and methods that can collect object-to-action-to-communication-to-conversion metrics for all behavior of consumers and businesses across the web and across any social business platform. The information can be compiled into complex 4th dimensional database systems. A method can then supply analytic measurements and insightful degrees of separation for social interaction, and/or global economic views.

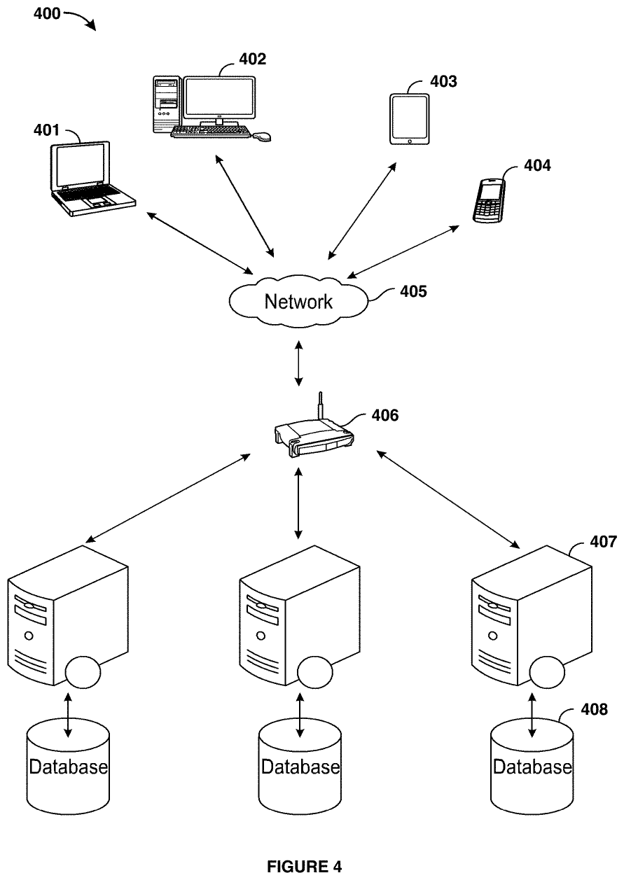

Referring to FIG. 4, a block diagram is illustrated of a network employing a method and system according to the invention. It is anticipated that the present web application system 400 operates with a plurality of computers which are coupled together on a network, such as the Internet 405, or other communications network. FIG. 4 depicts a network 405 that includes user computers 401, 402, 403, and 404 that communicate with one or more web servers 407 though communication links that include the Internet 405. The user computers 401, 402, 403, and 404 may be any type of computing device that allows a user to interactively browse web sites, such as a personal computer (PC) that includes a web browser (e.g., Microsoft Internet Explorer™ or Google Chrome™). Suitable user computers equipped with browsers are available in many configurations, including handheld devices 404 (e.g., Apple iPhone™, Google Android, or RIM Blackberry), personal computers (PC) 402, laptop computers 401, television set-top devices, tablets 403 and so forth.

The one or more web servers 407 may be optionally managed by a load balancer 406. Load balancer 406 may receive requests from computer network 405 and route these requests to one or more web servers 407 based on a variety of criteria. These criteria may optionally include the current load of each web server 407, session information included in the network request, a round robin counter maintained by load balancer 406 or other criteria.

One or more web servers may also communicate with one or more databases 408. These databases may be in a mirrored or striped configuration to support the data storage requirements of web applications running on web server(s) 407. The web server(s) 407 includes a server computer running a web interface application and capable of selectively delivering data files, such as HTML files, to the user computers using a protocol such as HTTP. Web server 407 may also dynamically generate content for delivery to user computers in response to a request from a user computer. The content may be generated by web server 407 directly, or may be generated by other computers linked to web server 407 in response to a request from web server 407. Web server 407 may then forward the requested content to a user computer over network 405.

In some embodiments, systems disclosed herein are configured to allow subscribers subscriber to create, publish, manage, and syndicate their products and/or services. The subscriber can create unlimited deals of any type and embed a preexisting ad creative (e.g., previously printed ad in newspaper or magazine), a single photo, or a video to give the offering more depth and information. Each deal created and managed by the subscriber can receive a unique, dedicated search visible page whereby users can access specific information on the business, on the deal, the redemption process, fine print disclosures, reviews, and locations. In some embodiments, each user or registered user that accesses a deal for consumption receives a voucher by email. In addition, information regarding users who accesses a deal may be provided to the subscriber.

Deals may be deleted, edited, changed, or de-listed at any time. The subscriber may be able to re-activate archived deals and thus a subscriber may have running inventory of deals that can be activated or de-activated in response to product overstocking, deeply discounted manufacturer incentives, seasonality, holidays, and many other categories which affect the type and nature of the offering to the public without recreating them Each newly created deal may be syndicated as desired. In some embodiments, archived or re-activated deals are not re-syndicated unless the subscriber wishes to push that information out to their respective networks. Registered users may capture deals and store them inside of their dashboard, referencing them immediately or at a later time through interior communication directly with the subscriber. In some embodiments, the system is configured to inventory all active deals on either a bi-weekly or monthly basis and blast deals to registered users that have pre-selected or filtered their deal preferences by product, service, and/or geography. The blast may comprise email sent to registered users and may include expiring deals and the new or popular deals in their area.

In some embodiments, a subscriber's digital space may include at least one page for the sale of products and/or offer for services. Such pages may have the same unique and dedicated search optimized structure as other media pages within the digital space, but with the distinction of being focused towards creating exposure and distribution for products and/or services. The platform may include an ecommerce based system. As described in further detail below, such an ecommerce system may include a Payment Card Industry (“PCI”) compliant methodology, or a cryptocurrency methodology for global transactions. Thus, in some embodiments, one or more pages of subscriber's digital space are configured to accept and process payments from users. In some embodiments, a user's digital space may interact with third party web site APis to provide an e-commerce APP to the subscriber ecommerce and/or virtual storefront pages. In some embodiments, the platform may include one or more software modules configured to syndicate product related content to social networks and ecommerce platforms such as Amazon, eBay, Etsy, Googlebase and others. The subscriber may be able to manage the experience, inventory, design, marketing, transactions, financial processing, shipping fulfillment, customer management, and more in an integrated manner that may be displayed in the subscriber's dashboard. In addition, the platform may capture, measure, and store metric and meta information relating to all sales the transactions, products, customers, sales and customer locations, previous purchases, pricing, demographics and other areas. Such information may be sorted, displayed, and analyzed using the subscriber's dashboard and/or displayed on a dedicated page on the subscriber's digital space.

In some embodiments, the platform is configured to enable subscribers to create, edit, manage, launch, measure, and/or processing a marketing campaign that interacts with social media, SEO, PPC, ad networks, gamification, drip email, and any other channels available to the subscriber. Such a marketing tool may be available on the subscriber's dashboard. The marketing tool may allow for the subscriber to tailor a marketing campaign by selecting uploaded content to be syndicated, selecting the time and date the content will be syndicated, and selecting the channels that the content is syndicated to. One or more modules may then distribute the selected content according to the subscriber's input. In some embodiments, a subscriber's database of uploaded content may be searched and navigated with a script driven framework that floats within the interface. A subscriber may then select content generated by that search for insertion into any campaign or campaign template. Thus, in some embodiments, a module accessible through a subscriber's dashboard is configured to organize, automate, and synchronize a subscriber's marketing campaign and is included within the platform. In some embodiments, one or more software modules can be configured to extract product information from a subscriber's pre-existing ecommerce pages or information. This module may then replicate this information on unique pages on the subscriber's digital space and/or throughout other social networks enabling multiple purchasing options for users.

In some embodiments, the platform is configured to store data regarding a user's social media uses in a digital database. This network itself can be configured to review the patterns of any number of users and mimic the same. The network can engage and interact with multiple social media services simultaneously. In another embodiment, the network can use historical data of successful business operations to launch similar strategy on digital spaces. The network itself can make recommendations for changes in advertisement strategies, SEO strategies, and engagement levels. The ability to seamlessly and transparently auto-post content, media, deals, advertisements, general notifications, and other elements to the subscriber's social media channels is limitless. Through a variety of integration methods, for example, partnership deals or general API connectivity, the platform may also be configured to update business listing information across local search properties, participating directories, and other channels. While a dashboard and/or admin-interaction page may contain controls for limited customization aspects, the platform may autonomously use successful campaigns to syndicate on multiple platforms. In some aspects content provided by a subscriber to their digital space can syndicate to the subscriber's social channels in a fully automated or partially automated manner. In some embodiments, the platform is configured to accept and push varying data communication protocols such as, for example, gets, http post requests, batch uploading, and general XML integration.

In some embodiments, media content is received from a subscriber. The subscriber may for add, edit, or delete the received content. The content may then be autonomously syndicated to one or more of the subscriber's social and/or other third-party media accounts. For example, the systems described herein allow for a subscriber to upload a video, edit the video, and syndicate the video to registered accounts for Limelight, YouTube, or any other registered video streams. In another example, subscribers may upload a message, deal, or other E-commerce product to selected social channels from the subscriber's list of registered social channels. The channels may be displayed in the subscriber's dashboard. Subscribers may also view all posts, messages, and/or articles that are syndicated to different social media channels and their respective analytics.

In another embodiment, the current platform allows a subscriber to monetize various aspects of their own online presence, including through offering services, and agreeing to provide data in exchange for targeted advertisements. Moreover, the network may be configured to collect data, and inform users of the value of said data to certain advertisers and publishers.

Another embodiment of the present invention seeks to connect subscribers and allow transactions on the platform using a decentralized network. The decentralized network provides several benefits including the ability to transact with virtual tokens, or cryptocurrency, the ability to deploy smart contracts, and the ability to provide additional security for data. This decentralized network will require at least one server, a processor, and at least one networking interface (“Network”). Such a Network will allow the connection of user devices through the Internet. The Network itself will consist of at least one server, which will host a webpage, that when executed, will allow users to access a portal and be identified cryptographically using a private key and public key. The web portal or other network connected device will provide a platform to connect a patent owner with other stakeholders in the patent process.

In one embodiment of the present invention, the decentralized network is a blockchain network. Blockchain technology (sometimes simply referred to as a blockchain) was developed and has been used in certain digital currency implementations. An example implementation and corresponding blockchain techniques are described in a 2008 article by Satoshi Nakamoto, called “Bitcoin: A Peer-to-Peer Electronic Cash System,” the entire contents of which are hereby incorporated by reference. With that being said, in certain embodiments discussed herein, the blockchain may be privately hosted (e.g., where all member nodes are run and provided by the same entity or a controlled group of entities). In certain example embodiments, the blockchain may be a distributed blockchain, such as the one provided by the bitcoin network. Thus, the term blockchain as used herein is not confined to the so-called blockchain that is only used for the bitcoin cryptographic currency.

The blockchain is a data structure that stores a list of transactions and can be thought of as a distributed electronic ledger that records transactions between source identifier(s) and destination identifier(s). Every transaction is “to” a destination identifier that is associated with a public/private key pair. In creating a new transaction, outputs from other, prior transactions that are to the “from” address (which may be multiple different addresses derived from the same private key) are used as inputs for this new transaction. The new transaction is then encumbered with the public key associated with the “to” destination identifier. In other words, outputs from prior blockchain transactions are used as inputs for new transactions that are then signed using the public key associated with the destination address. The new blockchain transaction is then submitted to the blockchain. Once on the blockchain multiple such transactions are bundled into a block and the block is linked to a prior block in the “blockchain.” Computer nodes of the distributed system then maintain the blockchain and validate each new block (along with the transactions contained in the corresponding block). The techniques described herein make use of blockchain technology to address one or more problems with the conventional database systems to provide a pooled resource for influencers.

A computer, network, or blockchain, may deploy a smart contract. A smart contract is computer code that implements transactions of a contract. The computer code may be executed in a secure platform (e.g., an Ethereum platform, IBM Hyperledger platform) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes initializing the smart contract and its state. The state of a smart contract is stored persistently in the blockchain (e.g., via a Merkle tree). When a transaction is recorded against a smart contract, a message is sent to the smart contract and the computer code of the smart contract executes to implement the transaction (e.g., debit a certain amount from the balance of an account, transfer the ownership of a patent). The computer processes the code and ensures that all the terms of the contract are complied with before the transaction is recorded in the blockchain. For example, a smart contract may request an exchange of one type of cryptocurrency token to another. The computer executes code to determine the exchange rate and transfers the correct number of tokens to and from the correct accounts.

The Blockchain network may include multiple computers, networks, links, and databases. Miners may manage the blockchain, whereas the managing may include, for example, validating a smart contract and/or transaction according to the smart contract, updating the blockchain with a validated smart contract and update the blockchain with a transaction that is executed according to the smart contract, determine that a suggested smart contract is invalid, determine that a transaction is not according to a smart contract, and the like.

In some embodiments, a smart contract may be accompanied by a digital certificate, or a digital signature which contains information regarding the source of the transaction. The computer, network, or blockchain will validate this information and determine the authenticity of the source of the transaction prior to deploying the smart contract. The smart contract may determine the rules for transferring virtual currency based on the occurrence of some event, and any other rules that should be applied during a transaction. The platform itself can construct a smart contract in real time based on inputs from a service provider and a user. In one embodiment, a user requests a service provider to provide various tasks such as a like on a birthday, or a comment on someone else's page. A smart contract containing the terms of the agreement is launched on the platform is autonomously deployed upon the occurrence of the proper events.

Finally, the Blockchain network can be deployed using a private ledger. As such, any data can be protected from attack using a plurality of databases. Should the ledger fail to resolve, the system can detect a breach. The blockchain typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person), and blocks are created by users known as “miners” who use specialized software/equipment to create blocks. In some embodiments, the block chain system disclosed, SS the number of miners in the current system are known and the system comprises primary sponsors that generate and create the new blocks of the system. As such, any block may be worked on by a primary sponsor. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases, that meets other criteria.

In one embodiment, the Network is made up of a plurality of nodes, each node connected to another node in the plurality of nodes, having the ability to pass data to each of the connected plurality of nodes. At least one node of the plurality of nodes is connected to an existing blockchain. Using this existing blockchain, the decentralized transactions can take place.

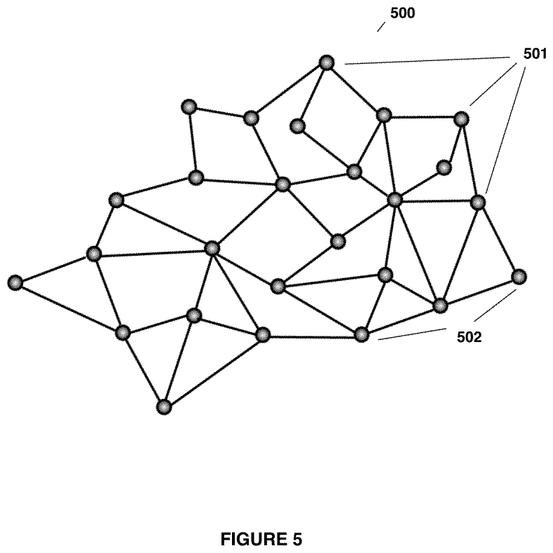

FIG. 5 depicts one aspect of the present invention. Specifically, the illustration shows the interconnection of each node 501 in a distributed decentralized network 500. In accordance with the preferred embodiment of the present invention, each node 501 in the distributed network 500 is directly connected to at least two other nodes 502. This allows each node 501 to transact with at least one other node 501 in the network.

In one embodiment, each transaction (or a block of transactions) is incorporated, confirmed, verified, included, or otherwise validated into the blockchain via a consensus protocol. Consensus is a dynamic method of reaching agreement regarding any transaction that occurs in a decentralized system. In one embodiment, a distributed hierarchical registry is provided for device discovery and communication. The distributed hierarchical registry comprises a plurality of registry groups at a first level of the hierarchical registry, each registry group comprising a plurality of registry servers. The plurality of registry servers in a registry group provide services comprising receiving client update information from client devices, and responding to client lookup requests from client devices. The plurality of registry servers in each of the plurality of registry groups provide the services using a quorum consensus protocol.

As another example, a method is provided for device discovery and communication using a distributed hierarchical registry. The method comprises Broadcasting a request to identify a registry server, receiving a response from a registry server, and sending client update information to the registry server. The registry server is part of a registry group of the distributed hierarchical registry, and the registry group comprises a plurality of registry servers. The registry server updates other registry servers of the registry group with the client update information using, at least in part, a quorum consensus protocol.

As another example, a computer-readable medium comprising computer executable instructions for causing a client device to perform a method for device discovery and communication is provided, the method comprising broadcasting a request to identify a registry server, receiving a response from a registry server, and sending client update information to the registry server. The registry server is part of a registry group of the distributed hierarchical registry, where the registry group comprises a plurality of registry servers. The registry server updates other registry servers of the registry group with the client update information using a quorum consensus protocol.

In some embodiments, the system is further able to conserve network and computing resources by securely storing information associated with user data, preventing potential malicious activity involving such information, conserving bandwidth, memory, and computation resources.

A digital wallet is software and hardware (or specifically designed hardware) that allows an individual to make electronic commerce transactions that use, a blockchain. The digital wallet is a data structure that can include a private key (e.g., that is only known to the holder of the wallet) and a series of identifiers (sometimes called wallet identifiers, blockchain identifier, or walletIDs herein) that have been generated based on the private key. These identifiers are used to allow other users to “send” transactions, which are recorded on the blockchain, to that identifier. For example, the above novation process creates two blockchain transactions for a trade between Publisher (“Party A”) and the distributed decentralized network administrator (“Party B”). A first blockchain transaction may be from the wallet of party A to the wallet of the Party B. A second blockchain transaction may be from the wallet of the Party B to a wallet of party A. These transactions may be separately generated and submitted to the blockchain. Alternatively, the blockchain may only have one “wallet” that is being used for interacting with the blockchain. Other types of implementations may also be possible (e.g., where different parties, or their respective computer systems, use their own keys for a central blockchain). In certain embodiments, the wallets may be centrally managed by the distributed decentralized network computer system that the parties associated with the trade. However, the transactions recorded to the blockchain may still be signed by or otherwise associated with the individual wallets of the patent stakeholders.

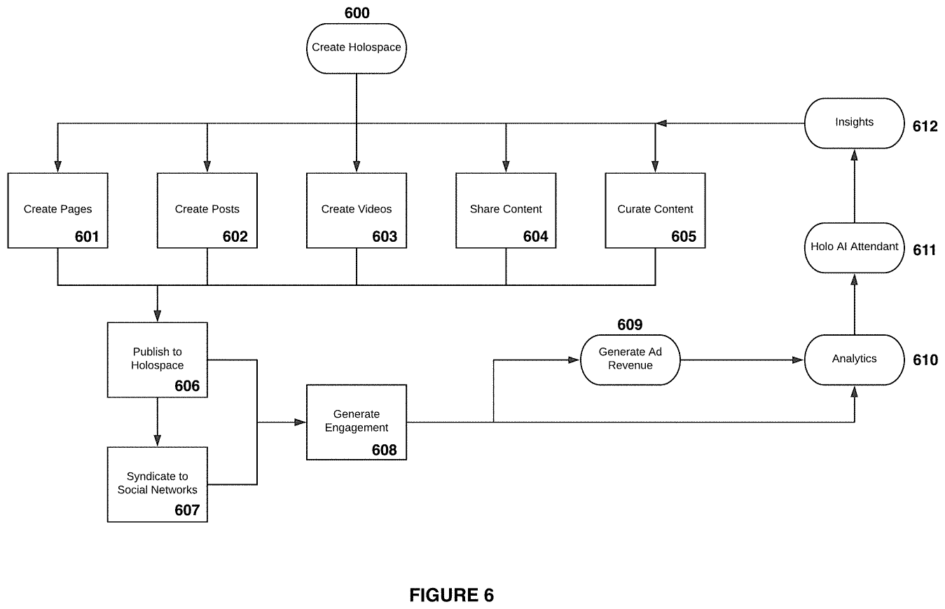

FIG. 6 depicts an embodiment of the overall advertising monetization method of the present invention. The process begins with the creation of a Holospace 600, whereby the user can then create content pages 601, posts 602, and videos 603, as well as share content 604 and curate content 605, all of which is published to the Holospace 606. Once any content is published to the Holospace 606, the user can syndicate content to external social networks 607. Engagement can then be calculated and generated 608 based on both the content published to the Holospace 606 and syndicated content on external social networks 607. The generated engagement 608 provides the data to generate advertising revenue 609 and analytical data 610. This analytical data 610 is processed through the “Holo” AI attendant 611. The AI attendant 611 is able to produce platform insights 612 that are constantly evolving based on the data processed through the AI attendant 611.

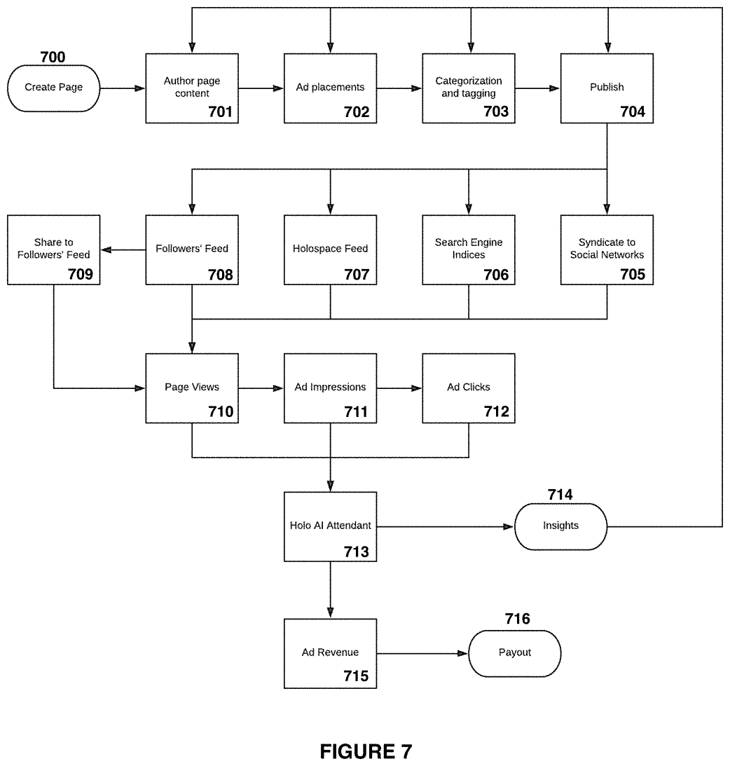

FIG. 7 represents one embodiment of the advertising monetization page creation method of the present invention. Once a page has been created 700, the next step is to provide page content 701, followed by advertisement placement 702. Once the page has been categorized and tagged 703, it can be published 704. The published page 704 can then be syndicated to external social networks 705, published to search engine indices 706, published to the Holospace feed 707, and published to the feeds of followers 708. Through the followers' feed 708, the page can be shared to their respective followers 709 as well. Page views 710 are generated from all streams the page has been published on and syndicated to, which then generates ad impressions 711 and ad clicks 712. The data collected from the page views 710, ad impressions 711, and ad clicks 712 is collected and processed by the “Holo” AI attendant 713. Through the AI attendant 713, data is analyzed through Insights 714. Based on the collected data, the AI attendant 713 also processes data for ad revenue 715 and payouts 716.

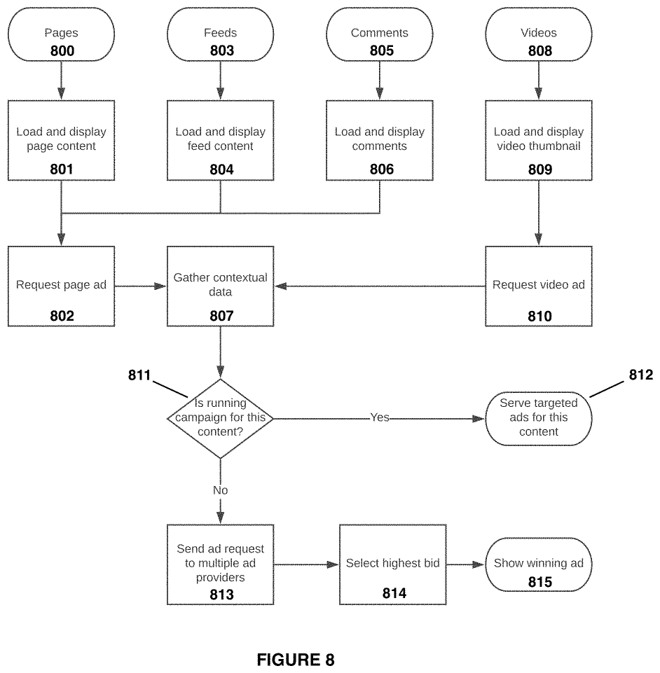

FIG. 8 represents one embodiment of the monetization advertisement placement method of the present invention. Advertisement placement can be determined through various channels, such as: published pages 800 that load and display page content 801; follower feeds 803 that load and display feed content 804; and user comments 805 that are loaded and displayed 806. All content displayed from these channels can be used to request a page advertisement 802. Another content channel is videos 808 that load and display thumbnails 809, in order to request a video advertisement 810. Contextual data is then gathered 807 based on all page 802 and video 810 advertising requests. Advertisements are then selected by determining if the advertiser is running a campaign based on the content 811 from the page or video request data. If it is determined that the advertisement is running a campaign for the content, then targeted ads are served 812. If there are no campaigns related to the content, then ad requests are sent to multiple providers 813, whereby the highest advertising bid is selected 814 and the winning ad is shown 815.

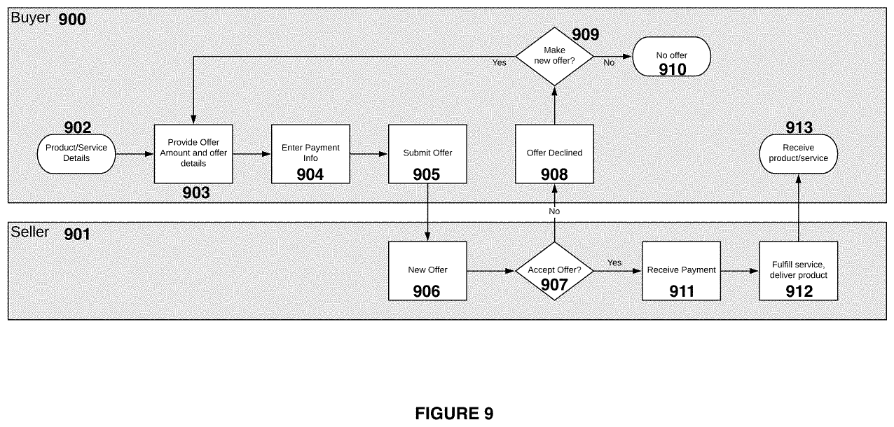

FIG. 9 depicts one aspect of the present embodiment, namely the buyer offer method. A buyer 900 can make an offer when there no minimum offer amount is specified by the seller 901. The buyer 900 can view product or service details 902, and provide an offer amount 903 by entering payment information 904 and submitting the offer 905. The Seller 901 is able to view the new offer 906 and decide whether or not to accept the offer 907. If the seller 901 declines the offer 908, the buyer 900 can then decide to make a new offer 909 or choose not to make a new offer 910. If the seller 901 decides to accept the offer 907, then the seller 901 receives payment 911 and must then fulfill the service or deliver the product 912 to be received by the buyer 913.

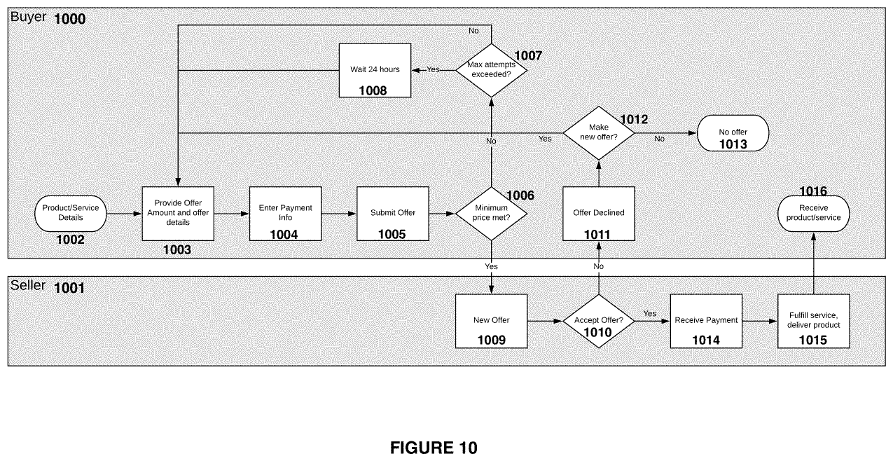

FIG. 10 depicts another embodiment of the buyer offer method of the present invention. A buyer 1000 can make an offer when a minimum offer amount has been specified by the seller 1001. The Buyer 1000 can view product or service details 1002, and provide an offer amount 1003 by entering payment information 1004 and submitting the offer 1005. If the submitted offer 1005 does not meet the minimum amount 1006 threshold and the buyer 1000 has not exceeded the maximum amount of offer attempts 1007, a new offer can be entered 1003. If the maximum amount of offer attempts 1007 has been reached, then the buyer 1000 must wait at least 24 hours 1008 before entering a new offer 1003. If the submitted offer 1005 meets the minimum price 1006 threshold, the Seller 1001 is able to view the new offer 1009 and decide whether or not to accept the offer 1010. If the seller 1001 declines the offer 1011, the buyer 1000 can then has the option to make a new offer 1012 or not make a new offer 1013. If the seller 1001 decides to accept the offer 1010, then the seller 1001 receives payment 1014 and must then fulfill the service or deliver the product 1015 to be received by the buyer 1016.

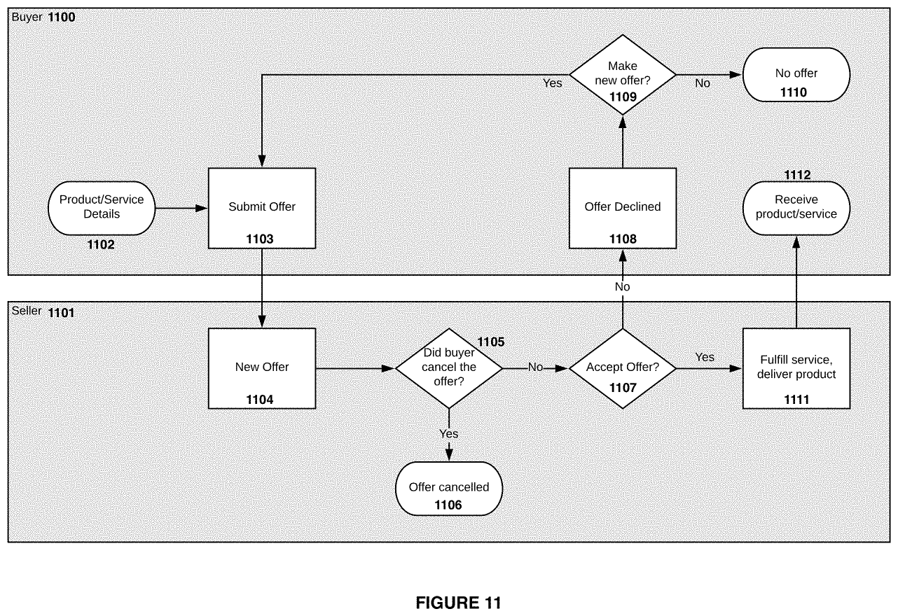

FIG. 11 depicts another aspect of one embodiment of the present invention, the cancellation process. The buyer 1100 can view product or service details 1102 and submit an offer 1103. The seller 1101 is able to view the submitted new offer 1104. If the buyer 1100 cancels the offer 1105, the offer is cancelled 1106 and no longer valid. If the buyer 1100 has not cancelled the offer 1105, the seller 1101 can decided whether or not to accept the offer 1107. If the seller declines the offer 1108, the buyer 1100 can then has the option to make a new offer 1109 or not make a new offer 1110. If the seller 1101 decides to accept the offer 1107, then the seller 1001 must then fulfill the service or deliver the product 1111 to be received by the buyer 1112.

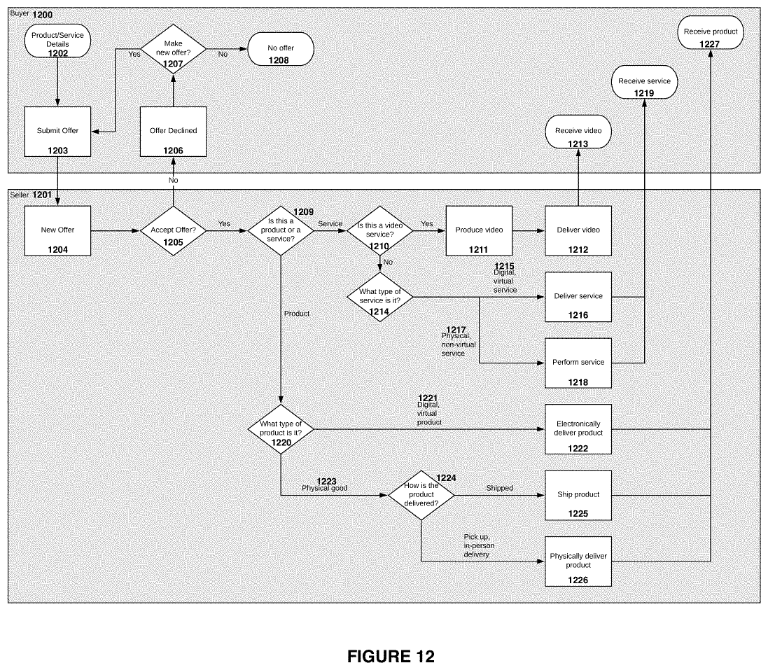

FIG. 12 depicts another aspect of one embodiment of the present invention, the fulfillment process. The buyer 1200 views product or service details 1202 and submits an offer 1203. The seller 1201 receives the new offer 1204 and can decide whether or not to accept the offer 1205. If the seller 1201 declines the offer 1206, the buyer 1200 can then has the option to make a new offer 1207 or not make a new offer 1208. If the seller 1201 accepts the offer 1205, then fulfillment is determined based on if the offer was for a product or a service 1209. If the seller 1201 is providing a service that is a video 1210, the video is then produced 1211 and delivered 1212 to the buyer 1213. If the seller 1201 is providing a service that is not a video, then the type of service is determined 1214 for fulfillment. If the service is digital or virtual 1215, it is provided electronically 1216 to the buyer 1219. If the service is physical and non-virtual 1217, then the seller performs the service 1218 received by the buyer 1219. If the accepted offer is for a product 1220 that is digital or virtual 1221, then the product is electronically delivered 1222 and received by the buyer 1227. If the accepted offer is for a product 1220 that is a physical good 1223, the seller 1201 can choose to ship the product 1225 or physically deliver the product 1226 to be received by the buyer 1227.

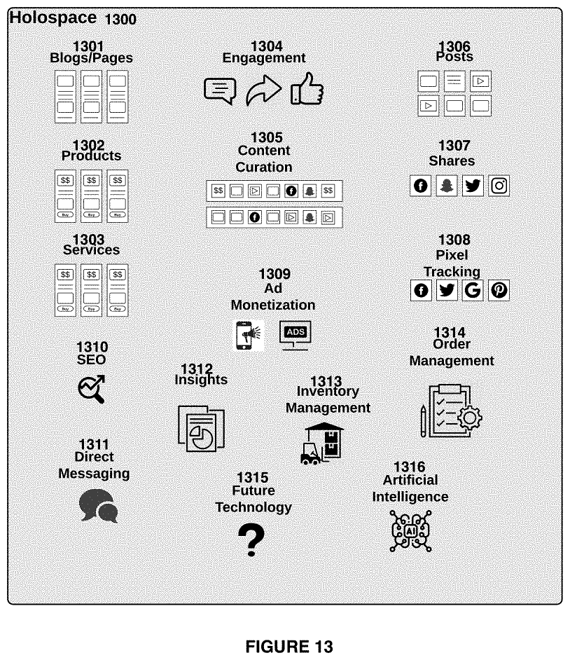

FIG. 13 depicts one embodiment of a potential aspect of the present invention, the combinatorial ecosystem. A Holospace 1300 is comprised of content blogs and pages 1301, products 1302, services 1303, and posts 1306. The Holospace 1300 allows for social networking engagement 1304 and the ability to curate all content 1305, as well as direct messaging 1311 between users. Content can be shared 1307 on external social networks and pixel tracking 1308 can also be utilized. The Holospace 1300 features Search Engine Optimization (“SEO”) 1310, ad monetization 1309 and data analytics through Insights 1312. The Holospace 1300 features e-commerce inventory management 1313 and order management capabilities 1314. The Holospace 1300 is entirely adaptable to future technology 1315 and artificial intelligence 1316 technology.

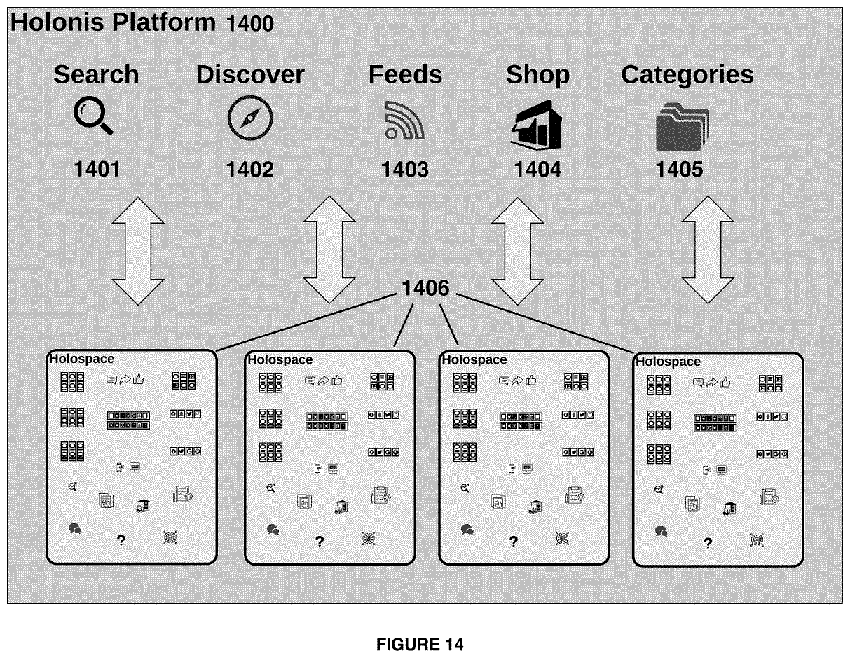

FIG. 14 is another embodiment of the combinatorial ecosystem platform. The Holonis platform 1400 provides a search function 1401, browsing discovery 1402, content feeds 1403, e-commerce shopping 1404, and content file categorization 1405 of various user Holospaces 1406.

The present invention also improves upon an individual user's presence through the use of artificial intelligence. A first neural network coupled to a network server containing a database of each users' individual Holospace inputs data related to each users' online presence and interactions. Through the user of a self-training artificial neural network object or STANNO, imaging cells which allow the STANNO to observe or input data located within the data space utilizing a cell referencing scheme. The artificial neural network which is to be trained is itself part of the STANNO, and at least some of the imaging cells may be representative of the input layer of the artificial neural network. The remaining imaging cells can be used by the STANNO to compare the actual output of the artificial neural network with the desired output associated with each particular input vector.

In general, training an artificial neural network requires a set of training data, including multiple input vectors and associated output vectors, and includes various techniques such as backpropagation, involving repetitive application of input vectors to an input layer of the artificial neural network. With each application of an input vector, the actual output of the artificial neural network, obtained at the output layer, can be evaluated in light of the desired output so that the connection weights and/or biases of the artificial neural network can be adjusted.

As used herein, the term “neural network” is intended to mean an actual or simulated (e.g., by computer program) network comprised of numerous, independent, highly interconnected artificial neurons which simulate the functions of biological neurons. Also, it will be understood that the neural network(s) may have one or more hidden layers.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program. The computer program may for instance include one or more of: a subroutine, a function, a procedure, an object method, an object implementation, an executable application, an applet, a servlet, a source code, an object code, a shared library/dynamic load library or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system (traditionally or according to the present invention) processes system data and user input and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices. The Internet of Things and associated cameras, sensors and mechanical and electronic input and output transducers will be monitored and controlled, along with geotagging equipment such as GPS receivers and biometric sensors.

The present technology requires a data processing system with sufficient memory and processing power to store and recall user data in real time. In addition, the invention may be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups. In particular, the distributed decentralized network discussed herein must be capable of analyzing user and bid data in a manner that can optimize the bidding process.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

In the foregoing specification, the invention has been described with reference to specific examples of embodiments of the invention. It will, however, be evident that various modifications and changes may be made therein without departing from the broader spirit and scope of the invention as set forth in the appended claims.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium. Any reference to “having”, “including” or “comprising” should be applied mutatis mutandis to “consisting” or “consisting essentially of.”

What is claimed is:

1. A system for optimizing a user's social commerce, the system capable of communicating with at least one user internet connected device, the system comprising:
a processor;
an accessible memory unit capable of storing computer executable instructions, when executed by the processor cause the system to transmit a user interface to the at least one of said user devices;
the system capable of interacting with multiple existing social media platforms for consideration and utilization by said user for the enhancement of user's social commerce and branding opportunities associated with said social commerce;
the user interface further capable of displaying and storing information related to information sources associated with each of said social media platforms, wherein said related feed information is processed by a processing attendant with artificial intelligence, which collects and manages information pertaining to historic user experiences, so that future user social commerce results may be optimized through an expansion process whereby said multiple existing social media platforms are optimally deployed for the benefit and utilization by said user; and
wherein said system is further capable of facilitating communication between any of said users to create a unique online brand presence associated with each of said users and optimized through competition between diversely controlled social media platforms and monitored and controlled by said artificial intelligence attendant, wherein historic social commerce results associated with each of said users is measured so that future user experiences may be optimized by bypassing proven less advantageous particular said multiple existing social media platforms diversely controlled and not associated with said system for optimizing said user's social commerce.

2. The system of claim 1, further configured to curate user's creation of content so that future user content is produced by said user in a manner predicted to enhance user's social commerce.

3. The system of claim 1, including a camera for use by said user to enable to create content via said camera, and then edit said content as to optimize user's said social commerce in advance of said content being associated publicly with said user, so that user's social commerce may be optimized privately and curated for further editing in advance of being posted publicly.

4. A method for optimizing a user's social commerce by way of internet communication comprising the steps of:
authenticating a user identity via a processing biometric attributes specific to said user;
accessing a memory unit capable of storing computer executable instructions, when executed by the processor cause the system to transmit a user interface to the at least one of said user devices;
interacting with multiple existing social media platforms for consideration and utilization by said user for the enhancement of user's social commerce and branding opportunities associated with said social commerce;
displaying and storing information related to diverse information sources via said user interface associated with each of said social media platforms, wherein said related feed information is processed by a processing attendant with artificial intelligence, which collects and manages information pertaining to historic user experiences, so that future user social commerce results may be optimized through an expanded outreach process whereby said multiple existing social media platforms are selected for utilization by said user to expand the social commerce of said user, and
facilitating communication between any of said users to create a unique online brand presence associated with each of said users and optimized through competition between diversely controlled social media platforms and monitored and controlled by said artificial intelligence attendant, wherein historic social commerce results associated with each of said users is measured so that future user experiences may be optimized by bypassing proven less advantageous particular said multiple existing social media platforms diversely controlled and not associated with said system for optimizing said user's social commerce.

5. The method of claim 4 wherein a user's creation of content is curated so that future user content is produced by said user in a manner predicted to enhance user's social commerce.

6. The method of claim 4, including using a camera to enable a user to create content via said camera, and then edit said content as to optimize user's said social commerce in advance of said content being associated publicly with said user, so that user's social commerce may be optimized privately and curated for further editing in advance of being posted publicly.

7. A method of developing a personal brand comprising the steps of:
enhancing social commerce by curating a user to create additional optimized content via a camera, microphone and written speech first offline wherein a user's own artificially attendant can evaluate said curated content in advance of it being posted publicly so that user will know the impact of said curated content upon a user's social commerce before said curated content it posted publicly;
providing optimized curated user content to more than one existing social media outlets, wherein said outlets bid the exclusive right to broadcast said optimized curated user content to each of their respective audiences so that user may optimize social commerce for the benefit of user; and
interpreting for the benefit of user social commerce analytics as developed over time, so as to optimize the process of curating user content in future social commerce content creation.

8. The method of claim 7 wherein a user's creation of content is curated so that future user content is produced by said user in a manner predicted to enhance user's social commerce by use of a user attendant with artificial intelligence, to create for a user a user internet space or internet of you.

9. The method of claim 7, including using a camera to enable a user to create content via said camera, and then edit said content as to optimize user's said social commerce in advance of said content being associated publicly with said user, so that user's social commerce may be optimized privately and curated for further editing in advance of being posted publicly.

10. The method of claim 9 wherein a user's creation of content is curated so that future user content is produced by said user in a manner predicted to enhance user's social commerce by use of a user attendant with artificial intelligence, to create for a user a user internet space or internet of you.

11. A method of developing a personal brand including:
empowering an individual to build a personal brand on the Internet and monetize said individual's creativity;
publishing said personal brand via the Internet users for creating commercial value to offer said commercial value to other Internet users; and
using artificial intelligence to expand and optimize said individual's social commerce to benefit said individual, by curating said individual to create more social media content for enhancing subsequent social commerce.

12. A method of enhancing a digital economy comprising:
using machine learning and artificial intelligence for creating personalized empowerment by expanding social commerce associate with individual internet users to democratize a digital economy;
wherein said artificial intelligence tracks analytics associated with Internet commerce participants and subsequently measures said participants ability to reach the widest possible financially viable audience while optimizing said reach so that each participant manages its own social commerce for maximum financial profit.
